(19) United States
(12) Patent Application Publication
(10) Pub. No.: US 2002/0010687 A1
(43) Pub. Date: Jan. 24, 2002

(54) Mail preparation system

(76) Inventor: David Anthony Gawler, Sittingbourne (GB)

Correspondence Address: Charles W. Fallow, Shoemaker and Mattare, Suite 1203, 2001 Jefferson Davis Highway, Arlington, VA, 22202, US

(21) Appl. No.: 09/867,763

(22) Filed: May 31, 2001

(30) Foreign Application Priority Data
Jun. 1, 2000 (GB) 0013152.4

(51) Int. Cl. G07B 17/02

(52) U.S. Cl. 705/401

(57) ABSTRACT

The present invention relates to a mail preparation system. In one aspect the present invention provides a mail preparation system, including: a postage charge dispenser configured to generate postage indicia and account for postage charges; a printer operable to print the postage indicia as generated by the postage charge dispenser on mail items; a display; a controller for driving the display to display a depiction of a postage indicium to be printed on a mail item, the depicted postage indicium including a plurality of data items modifiable by a user, which data items include at least one data item related to postage charge, and being operable to provide data representative of the data items to the postage charge dispenser; a data item selector operable by the user to select any one of the data items in the depicted postage indicium and cause the controller to drive the display to display a plurality of possible item entries for the selected data item; and an item entry selector operable by the user to select one of the possible item entries for the selected data item and cause the controller to drive the display to display a modified depiction of the postage indicium including the selected item entry for the data item. In another aspect the present invention provides a mail preparation system for preparing batches of mail, the system including: a message transmitter operable to transmit messages relating to batches of mail to a remote data center; a message receiver for receiving messages from the remote data center as an acknowledgement in reply to each transmitted message; a display for displaying message areas corresponding to each transmitted message; and a controller for operating the display to display the message areas with a first visual appearance on transmission of the respective messages to the remote data center and a second, different visual appearance on receipt of the respective messages from the remote data center.

### BACKGROUND OF THE INVENTION

The present invention relates to a mail preparation system, in particular for dispensing postage charges in respect of mail items, and more particularly to a user interface for enabling the operation of such a system by an operator.

In known postage dispensing apparatus, for example, postage meters, the apparatus is provided with a display for displaying information to a user and a keyboard for enabling the user to input postal data and select operations required to be performed by the apparatus. The keyboard includes operation keys corresponding to different operations of the apparatus and a set of numerical keys. When a postage dispensing operation is selected, the numerical keys each correspond to a different numerical value, whereby the value of the postage charge desired to be applied to a mail item is selected by operation of the appropriate key or keys.

### SUMMARY OF THE INVENTION

In one aspect the present invention provides a mail preparation system, including: a postage charge dispenser configured to generate postage indicia and account for postage charges; a printer operable to print the postage indicia as generated by the postage charge dispenser on mail items; a display; a controller for driving the display to display a depiction of a postage indicium to be printed on a mail item, the depicted postage indicium including a plurality of data items modifiable by a user, which data items include at least one data item related to postage charge, and being operable to provide data representative of the data items to the postage charge dispenser; a data item selector operable by the user to select any one of the data items in the depicted postage indicium and cause the controller to drive the display to display a plurality of possible item entries for the selected data item; and an item entry selector operable by the user to select one of the possible item entries for the selected data item and cause the controller to drive the display to display a modified depiction of the postage indicium including the selected item entry for the data item.

Preferably, the data item selector comprises a screen pointing device.

More preferably, the screen pointing device comprises one of a mouse, a tracker ball, a touch pad or a touch screen.

Preferably, the item entry selector comprises a screen pointing device.

More preferably, the screen pointing device comprises one of a mouse, a tracker ball, a touch pad or a touch screen.

Preferably, the possible item entries for the selected data item are superimposed on the depiction of the postage indicium.

Preferably, the data items include postage value.

Preferably, the data items include postage class.

Preferably, the data items include date.

Preferably, the data items include destination.

More preferably, the destinations are represented on a map.

Preferably, the system further includes: a weighscale for determining the weight of mail items, the weighscale being operable to provide data representative of the weight of a mail item to the controller and the controller being configured automatically to select the postage value for the mail item.

In another aspect the present invention provides a method of preparing mail items, including the steps of: displaying a depiction of a postage indicium to be printed on a mail item, the depicted postage indicium including a plurality of data items modifiable by a user, which data items include at least one data item related to postage charge; selecting one of the data items in the depicted postage indicium to be modified; displaying a plurality of possible item entries for the selected data item; selecting one of the possible item entries for the selected data item; displaying a modified depiction of the postage indicium including the selected item entry for the data item; generating a postage indicium corresponding to the modified depiction of the postage indicium; and printing the postage indicium on a mail item.

Preferably, the possible item entries for the selected data item are superimposed on the depiction of the postage indicium.

Preferably, the data items include postage value.

Preferably, the data items include postage class.

Preferably, the data items include date.

Preferably, the data items include destination.

More preferably, the destinations are represented on a map.

Preferably, the method further includes the step of: weighing the mail item, whereby the weight of the mail item is utilised automatically to select the postage value for the mail item.

In a further aspect the present invention provides a mail preparation system for preparing batches of mail, the system including: a message transmitter operable to transmit messages relating to batches of mail to a remote data center; a message receiver for receiving messages from the remote data center as an acknowledgement in reply to each transmitted message; a display for displaying message areas corresponding to each transmitted message; and a controller for operating the display to display the message areas with a first visual appearance on transmission of the respective messages to the remote data center and a second, different visual appearance on receipt of the respective messages from the remote data center.

Preferably, the controller includes a time-out function for displaying message areas with a third, different visual appearance where a message is not received from the remote data center within a predetermined period of time following transmission of the message to the remote data center.

In one embodiment the different visual appearances are represented by different colours.

In another embodiment the different visual appearances are represented by different shades.

In a further embodiment the different visual appearances are represented by different patterns.

In a yet further embodiment the different visual appearances are represented by different characters.

In a yet further aspect the present invention provides a method of preparing batches of mail, the method including the steps of: transmitting messages relating to batches of mail to a remote data center; receiving messages from the remote data center as an acknowledgement in reply to the transmitted messages; and displaying message areas on a display corresponding to each transmitted message, the message areas being displayed with a first visual appearance on transmission of the respective messages to the remote data center and a second, different visual appearance on receipt of the respective messages from the remote data center.

Preferably, the method further includes the step of: displaying message areas with a third, different visual appearance where a message is not received from the remote data center within a predetermined period of time following transmission of the message to the remote data center.

In one embodiment the different visual appearances are represented by different colours.

In another embodiment the different visual appearances are represented by different shades.

In a further embodiment the different visual appearances are represented by different patterns.

In a yet further embodiment the different visual appearances are represented by different characters.

### BRIEF DESCRIPTION OF THE DRAWINGS

A preferred embodiment of the present invention will now be described hereinbelow by way of example only with reference to the accompanying drawings, in which:

FIG. 1 illustrates a block diagram of a mail preparation system in accordance with a preferred embodiment of the present invention;

FIG. 2 illustrates part of a mail item bearing an imprint of a postage indicium;

FIG. 3 illustrates a main operating display screen of the system of FIG. 1;

FIG. 4 illustrates the main operating display screen of FIG. 3, with a first drop-down menu superimposed thereon;

FIG. 5 illustrates the main operating display screen of FIG. 3, with a second drop-down menu superimposed thereon; and

FIG. 6 illustrates a message status display screen.

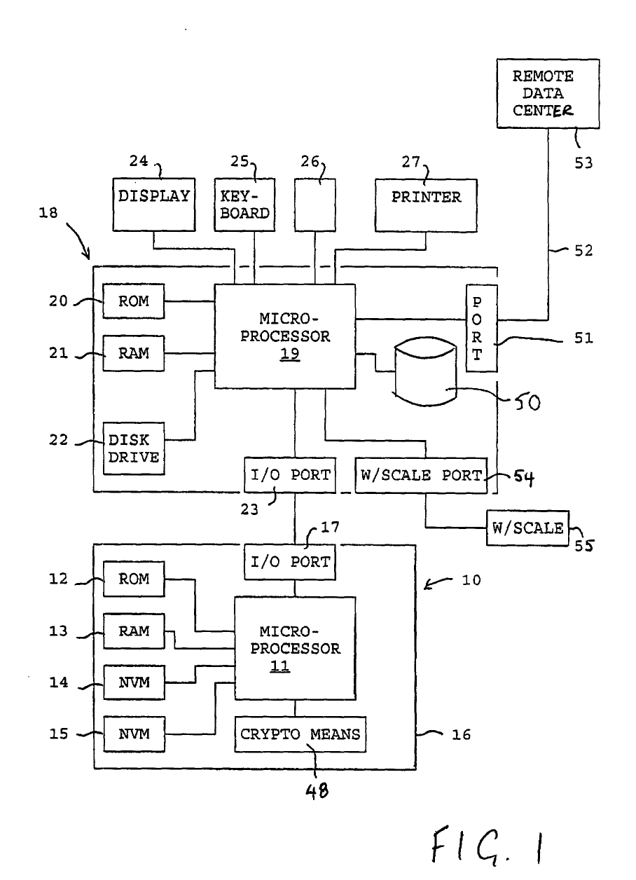

### DESCRIPTION OF A PREFERRED EMBODIMENT

The system includes a postal secure device (PSD) 10 which is operable to perform accounting in respect of the dispensing of postage charges in relation to mail items.

The PSD 10 includes electronic accounting means comprising a microprocessor 11, a read-only memory (ROM) 12 storing program routines for operation of the microprocessor 11, a random access memory (RAM) 13 for use as a working store for the temporary storage of data during operation of the PSD 10, and non-volatile duplicated memories 14, 15 for the storage of critical data relating to the use of the PSD 10, in particular the storage of accounting data relating to the dispensing of postage charges which is required to be retained even when the PSD 10 is not powered.

The microprocessor 11 performs accounting functions in relation to the dispensing of postage value in respect of amounts of postage charges applicable to the handling of mail items by a postal authority or other carrier. The accounting data usually includes a value of credit, an accumulated total of the value dispensed by the PSD 10 in respect of mail items, a count of the number of mail items processed by the PSD 10 and a count of the number of mail items on which a postage charge in excess of a predetermined value has been dispensed. The value of credit may be a value of credit which is available for use by the PSD 10 and stored in a descending credit register. The accumulated total value is stored in an ascending tote register, the count of items is stored in an item count register and the count of items to which a postage charge in excess of a predetermined value is applied is stored in a large items register. In an alternative embodiment, instead of a descending register storing the value of credit available for use by the PSD 10, the total value of credit entered in the PSD 10 may be stored in an ascending credit register.

As is well known in the postage meter art, each of the registers referred to hereinbefore for storing accounting data is replicated in order to enable the integrity of the accounting data to be maintained even in the event of a fault or termination of power to the PSD 10 during operation of the system. Two replications of each of the registers are provided in each of the memories 14, 15.

The components of the PSD 10 are housed in a secure housing 16 to provide for security against unauthorised tampering thereof.

The PSD 10 includes an input/output port 17 which is connected to the microprocessor 11 and provides for external communication with the microprocessor 11.

The PSD 10 includes cryptographic means 48 for generating cryptographic data for inclusion in postage indicia to be printed on mail items. In this embodiment the cryptographic means 48 is included in hardware separate from the microprocessor 11 for generating signatures or encrypting information. In an alternative embodiment the cryptographic means 48 could be implemented by the microprocessor 11 operating under software routines to generate digital signatures or encrypt information.

The system further includes a controller 18, in this embodiment a computer, for controlling the operation of the PSD 10, which computer 18 communicates via the input/output port 17 of the PSD 10.

In a preferred embodiment the computer 18 is a desk-top computer which comprises a microprocessor 19, a read-only memory (ROM) 20 storing program instructions, a random access memory (RAM) 21 for use as a working store, and at least one disk drive 22 which is operably connected to the microprocessor 19. The computer 18 operates under a Windows™ operating system which is stored on the disk drive 22 and downloaded to the RAM 21 when required to be accessed by the microprocessor 19.

The computer 18 includes an input/output port 23 which is connected to the microprocessor 19 and utilised to communicate via the input/output port 17 of the PSD 10 with the microprocessor 11 of the PSD 10.

The computer 18 includes a display 24 for displaying information to an operator of the system, a keyboard 25 for the input data and operating instructions by the operator of the system, and a screen pointing device 26, such as a mouse or tracker ball, for use by the operator to select items displayed on the display 24.

The computer 18 includes a database 50 which, in this embodiment, is stored internally. In an alternative embodiment the database could be stored externally. In preferred embodiments the database 50 is stored in one or more hard disk drives or in other non-volatile memories.

The computer 18 includes a communication port 51 for communication over a communication link 52 with a remote data centre 53 of a postal authority. The communication link 52 may be provided by a telephone data link and may utilise the Internet communication system.

The computer 18 includes a weighscale port 54 for connection to a weighscale 55 and communicate signals indicative of the weight of mail items to the microprocessor 19.

The system further includes a printer 27 which is operable under control of the computer 18 to print postage indicia on mail items.

The system further includes a weighscale 55 which is connected to the microprocessor 19 of the computer 18 through the weighscale port 54 to provide signals indicative of the weight of mail items to the microprocessor 19.

When the system is required to dispense postage charges in respect of mail items and print postage indicia on the mail items, the operator enters, by means of the keyboard 25 or the screen pointing device 26, a selection of a mail preparation program and instructions to run the program. In this embodiment the program is stored on a hard disk of the disk drive 22, and, when selected to be run, the program is loaded into the RAM 21 for access by the microprocessor 19 during running of the program. If desired, the computer 18 may be arranged to run the mail preparation program automatically upon power-up of the system. Running of the mail preparation program causes the microprocessor 19 to operate the display 24 to display a main operating screen as illustrated in FIG. 3, to which reference will be made hereinafter.

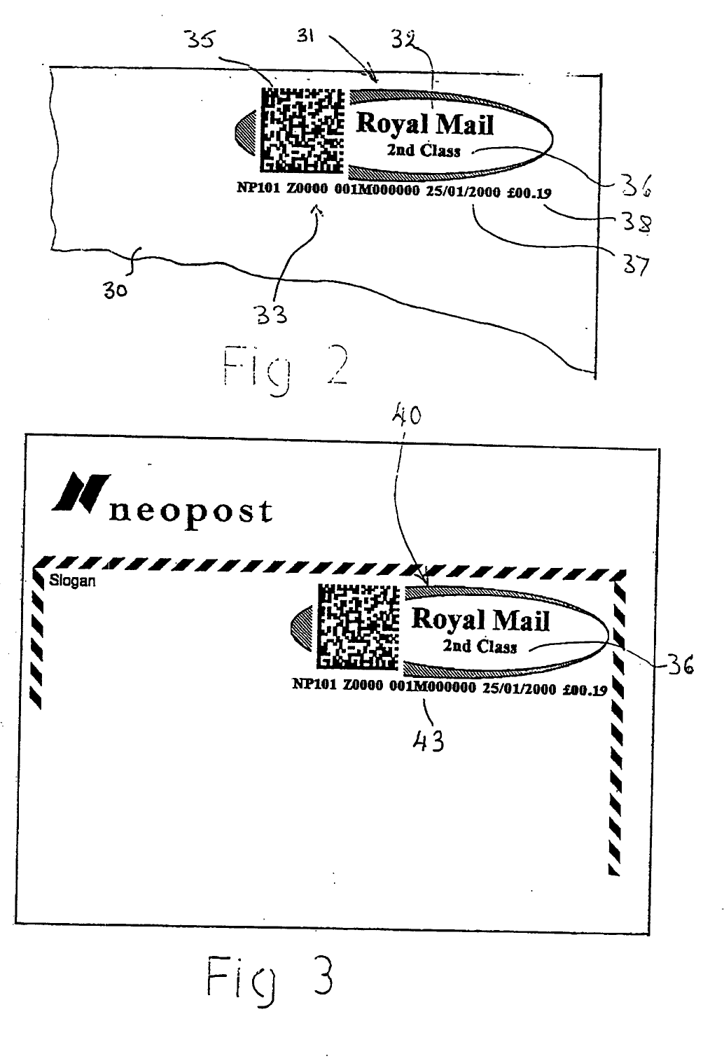

Referring to FIG. 2, a mail item 30 includes a postage indicium 31 in a form authorised by a postal authority, which postage indicium 31 includes a graphic design 32 incorporating a designation of the postal authority and postal data 33. In the exemplified postage indicium 31, the postal authority is the Royal Mail. The postal data 33 includes data supplied by the PSD 10, which data includes an identification of the supplier of the PSD 10, an identification serial number for the PSD 10, a unique identification in the form of a batch identification and an item number for the mail item. The postal data 33 also includes modifiable postal data items, the value of which may be selected by the operator of the system. These modifiable postal data items include the class of mail 36, the date 37 of posting for the mail item 30 and the postage charge 38 applied to the mail item 30. The values of these postal data items are selectable by the operator as described hereinafter, with the computer 18 inputting the values of these postal data items to the PSD 10. The PSD 10 performs accounting in respect of the value of the postal data item relating to postage charge 38, generates a postage indicium 31 based upon and including the values of the postal data items, and outputs the postage indicium 31 to the computer 18. The computer 18 then operates the printer 27 to print the postage indicium 31 received from the PSD 10 on the mail item 30.

The postage indicium 31 generated by the PSD 10 also includes cryptographic data, for example, a digital signature or encryption of postal data, to enable the authenticity of the printed postage indicium 31 to be verified by a verification system operated by the postal authority. The cryptographic data is printed in machine readable 2D or datamatrix form in an area 35. The cryptographic data included in the postage indicium 31 is generated by the cryptographic means 48 in the PSD 10. The cryptographic data is generated from the postal data included in the postage indicium 31, whereby the cryptographic data printed on the mail item 30 may be utilised to verify the postal data in the postage indicium 31 printed on the mail item 30.

With reference to FIG. 3, the main operating screen includes a depiction 40 of the postage indicium 31 for printing on a mail item 30. As described hereinbefore, some of the postal data included in the postage indicium 31 is selectable by an operator of the system, and the operator is required to input the selected postal data so that the PSD 10 can generate a required postage indicium 31 to be printed on the mail item 30. If the postal data depicted in the main operating screen is as desired by the operator, the operator accepts the depicted postage indicium 40 and inputs an instruction to cause the PSD 10 to perform the accounting procedure, generate the postage indicium 31 and output the generated postage indicium 31 to the computer 18 for operation of the printer 27 to print the postage indicium 31 on a mail item 30. If, however, any of the selectable postal data items for the mail item 30 is required to be different from that in the depiction 40 in the main operating screen, the operator may select a different value for the postal data item for inclusion in the postage indicium 31, as will now be described in more detail hereinbelow.

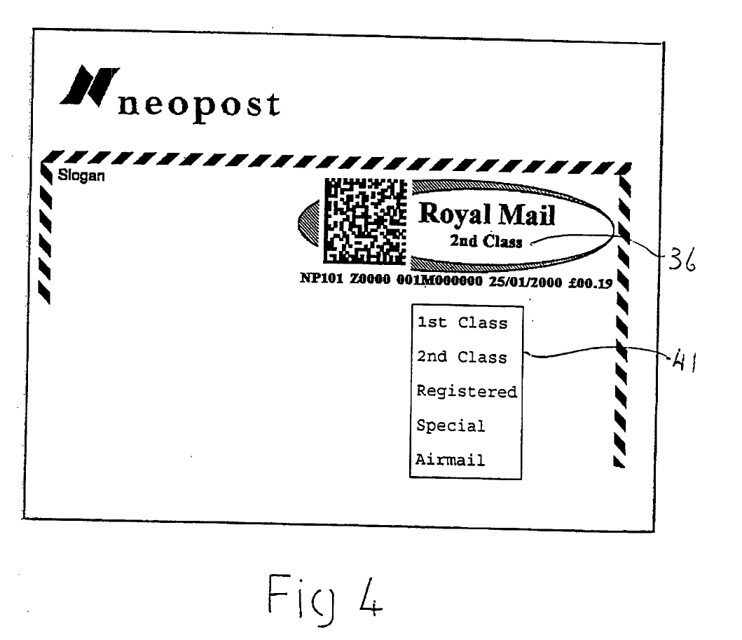

With the main operating screen displayed to the operator, the operator uses the screen pointing device 26 to select one of the postal data items in the depiction 40 of the postage indicium which requires modification. For example, if the postal data item 36 designating the desired class of mail is to be changed from ‘2^{nd} Class’, as depicted, to, for example, ‘1^{st} Class’, the operator uses the screen pointing device 26 to point to the data item ‘2^{nd} Class’ in the depicted postage indicium 40. Operation of the screen pointing device 26 enables the mail preparation program running in the computer 18 to recognise that the postal data item 36 designating the class of mail has been selected, and the computer 18 runs a sub-routine of the mail preparation program to display a drop-down menu 41 which is superimposed on the main operating screen, as illustrated in FIG. 4, to provide the options of ‘1^{st} Class’, ‘2^{nd} Class’, ‘Registered’, ‘Special’ and ‘Airmail’ for selection by the operator using the screen pointing device 26. Upon selection of the data item ‘1^{st} Class’, the computer 18 running the mail preparation program substitutes ‘1^{st} Class’ in the postal data item 36 in the depicted postage indicium 40 in place of ‘2^{nd} Class’. It will be understood that the selectable options of the class of mail referred to hereinbefore are given by way of example only and that other options may be provided and displayed in a drop-down menu for selection by the operator. When the class of mail has been selected, the postal data item 38 relating to postal charge is changed by the mail preparation program to a postage charge appropriate to the selected class of mail. Generally, the postal data item 38 is changed to a minimum value of postage charge applicable to the selected class of mail. If desired, however, the postal data item 38 may be changed to a value of postage charge above the minimum value, and, where the weighscale 55 is provided to input signals indicative of the weight of a mail item 30, the mail preparation program is operative to select the postage charge applicable in respect of the selected class of mail and applicable to the weight of the mail item 30 as determined by the weighscale 55.

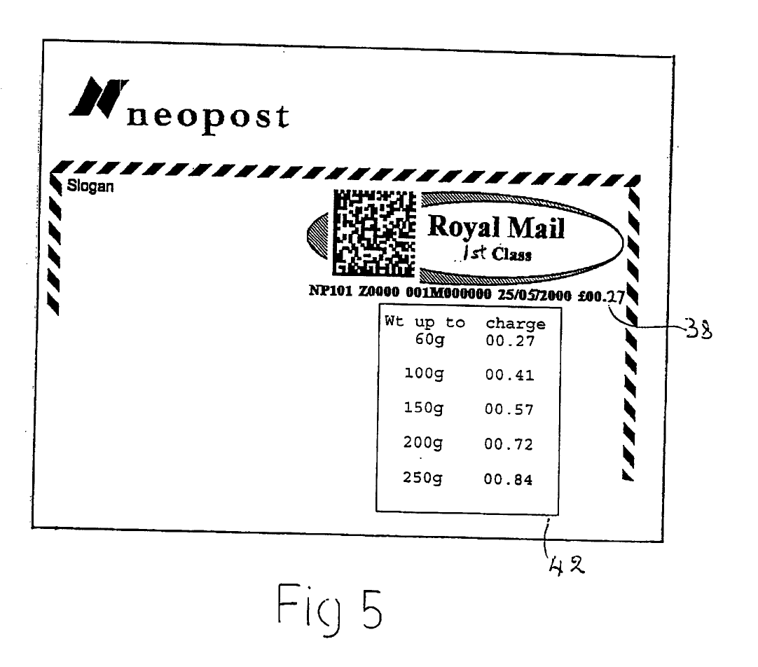

When a weighscale is not provided, the operator may select the postal data item 38 relating to postage charge to modify the postage charge by selection of a postage charge from a table of postage charges appropriate to the selected class of mail. Tables of postage charges for each class of mail are stored, and the table of charges relating to the selected class of mail is displayed in a drop-down menu 42 when the operator selects the postal data item 38. Selection of the postal data item 38 relating to postage charge is effected by the operator using the screen pointing device 26 to point to the postal data item 38 in the depicted postage indicium 40. If ‘1^{st} Class’ is depicted in the postage indicium 40, selection of the postal charge item 38 causes the computer 18 to display a drop-down menu 42 of postage charges in respect of 1^{st} Class mail of different weights which is superimposed on the main operating screen, as illustrated in FIG. 5. For example, the drop-down menu 42 may display 27p, 41p, 57p, 72p and 84p, as currently charged by the Royal Mail for 1^{st} Class mail items, and maximum weights to which these postage charges respectively are applicable. Postage charges applicable in respect of higher weights may be displayed by scrolling down the drop-down menu 42. However, if ‘2^{nd} Class’ is depicted in the depicted postage indicium 40, selection of the postal charge item 38 causes the computer 18 to display a drop-down menu of postage charges in respect of 2^{nd} Class mail of different weights which is superimposed on the main operating screen. For example, the drop-down menu may display 19p, 33p, 44p, 54p and 66p, as currently charged by the Royal Mail for 2^{nd} Class mail items, and the maximum weights to which these postage charges respectively are applicable. Similarly, other drop-down menus of postage charges are displayed in correspondence with other classes of mail that are selected. Selection of a required value of postage charge from the displayed drop-down menu 42 is effected by the operator using the screen pointing device 26 to point to the required value of postage charge in the drop-down menu 42. The computer 18 running the mail preparation program recognises the postage charge selected by the screen pointing device 26 and modifies the value of the postal charge data item 38 to the selected value of postage charge and causes the microprocessor 19 to display the selected value of postage charge in the depicted postage indicium 40 in the main operating screen.

In addition to the selection of the class of mail and the value of postage charge, the operator may select a batch of mail items in which the mail item 30 is to be included and the date on which the batch of mail is intended to be delivered to the postal authority. To select a batch of mail in which the mail item 30 is to be included, the operator points to the postal data item 43 relating to the batch of mail using the screen pointing device 26, the four most significant characters of which identify the batch and the less significant characters of which comprise a mail item number. Pointing to the postal data item 43 causes the mail preparation program to display a drop-down menu of existing batch identifications or batch names. The operator can select an existing batch name from the drop-down menu or the ‘new’ function from the drop-down menu, in which case the computer 18 then allocates a new unique batch identification for a new batch of mail items. If desired, the operator may choose to enter a name for the new batch of mail. To select a date for the mail item 30 which is different from the date displayed in the depicted postage indicium 40, the operator points to the postal data item 37 which represents the date and a drop-down menu comprising a calendar of dates is displayed to enable the operator to select a required date.

It will be appreciated that the amount of postage charge for a mail item 30 may vary according to the destination of the mail item 30. For example, in respect of mail items 30 to be sent to states or countries different from the state or country of origin, either by surface mail or airmail, the amount of postage charge may be dependent upon the destination state or country. Accordingly, the classes of mail may include at least one class for destination states or countries different from the state or country of origin. Upon selection of one of these classes by the operator, a drop-down menu of names of destination states or countries from which the operator can make a selection is displayed. Alternatively, a map may be displayed and the operator can point to a required destination or zone on the map. Selection of a destination then causes the mail preparation program to display a menu of postage charges corresponding to the selected destination.

When the data items displayed in the depicted postage indicium 40 have values as required by the operator, the operator may effect an input to the computer 18 indicating that the values of the operator-selectable postal data items are as required and accept the depicted postage indicium 40. The computer 18 then inputs the selected values of the operator-selectable postal data items to the PSD 10 and initiates the PSD 10 to effect an accounting routine and generate a postage indicium 31 based on these values. When the PSD 10 has generated the postage indicium 31, the PSD 10 outputs the postage indicium 31 to the computer 18 and the computer 18 operates the printer 27 to print the postage indicium 31 on the mail item 30.

Thus, it will be appreciated that the computer 18 running the mail preparation program causes a depiction 40 of a postage indicium to be displayed to an operator of the system and enables the operator to select and modify postal data items in the depicted postage indicium 40, whereby the operator sees a visual image of a current state of the postage indicium 31 prior to acceptance.

The system may be utilised by a mailer to prepare individual mail items 30 or batches of mail items 30, each batch of mail having an identification and mail items 30 within a batch of mail having an item count within the batch. If desired, a batch of mail may be sub-divided into sub-batches, and, where the term batch is used herein, the term batch is to be understood as including a batch or a sub-batch of mail. In handling a batch of mail, it is required that messages pass between the mail preparation system of the mailer and a postal authority that is to receive and distribute the batch of mail.

The handling of a batch of mail is effected in phases. The first phase, known as an announcement phase, relates to the preparation of a batch of mail items 30, and the second phase, which follows the first phase, known as an induction phase, relates to the handling of a completed batch of mail items 30 by the postal authority.

In the announcement phase, a ‘Pre-Announcement Message’ may be sent by the mailer to the postal authority, informing the postal authority of the intent of the mailer to prepare a batch of mail. When a batch of mail has been prepared and completed, a ‘Full Announcement Message’ comprising a statement of the mailing, which provides information relating to the mail items 30 contained in the batch, is sent by the mailer to the postal authority. During the preparation of the batch of mail, it is possible that some of the mail items 30 may suffer damage or be otherwise spoilt, and thus withdrawn from the batch of mail. In this case, a ‘Modified Announcement Message’, which provides information relating to the modification of the batch of mail as a result of the withdrawal of mail items 30, is sent by the mailer to the postal authority.

When a batch of mail has been completed and is ready for collection from the mailer or for delivery to the postal authority, the induction phase is initiated and an ‘Induction Advised Message’ is sent to the postal authority. The ‘Induction Advised Message’ informs the postal authority that an identified batch of mail is ready for collection from the mailer or for delivery to the postal authority.

When a message sent by the mailer is received by the postal authority, the postal authority sends back an ‘Acknowledgement Receipt Message’ to the mailer, whereby the mailer is assured that the information in that message has been received by the postal authority.

When the postal authority has collected the batch of mail or the batch of mail bas been delivered to the postal authority, and the batch of mail has been officially received by the postal authority, for example, at a postal authority sorting depot, the postal authority sends an ‘Induction Acceptance Message’ to the mailer, informing the mailer that the batch of mail has been received by the postal authority. After receipt of the batch of mail, the postal authority may carry out checks on the batch of mail to ensure that the physical batch of mail corresponds to the listing of the mail items 30 in the ‘Full Announcement Message’, and, when the postal authority has checked the postage indicia on the mail items 30 in the batch of mail and is satisfied that the postage charge data meets the postal authority acceptance criteria, the postal authority sends an ‘Agreed Message’ to the mailer.

Information relating to the mail items 30 in each batch of mail is held in the database 50 of the computer 18 and the information in the database 50 is utilised in the generation of the messages described hereinbefore and sent by the mailer to the postal authority.

It will be appreciated that a number of different batches of mail may be at different stages in the announcement and induction phases. As such, it is desirable to be able easily to determine the stage reached by any batch of mail and to check that there has not been a failure in the communication of any of the messages.

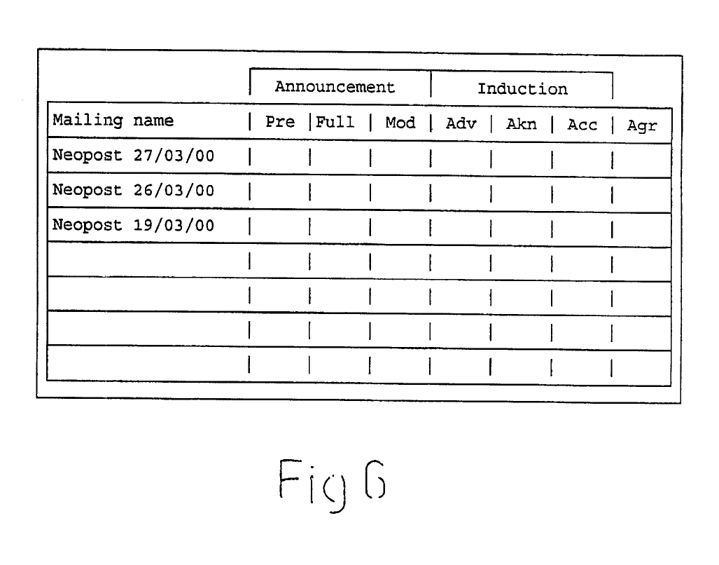

Accordingly, when required by the operator, the computer 18 running the mail preparation program can display a message status screen, as illustrated in FIG. 6. In this embodiment the message status screen is tabular in form, having a plurality of cells arranged in columns, which columns relate respectively to each of the messages described hereinbefore, and in rows, which rows relate respectively to each batch of mail. Each column is provided with a column title identifying the mailing name assigned to a batch of mail. The cells of the message status screen normally have a background colour, for example, white, and, when a message has been sent by the mailer, the cell corresponding to that message and to the batch in respect of which the message has been sent is caused to assume a selected different colour, the selected colour being indicative of the status of that message.

When a message is sent by the mailer to the postal authority in respect of a batch of mail, the cell corresponding to that message and that batch is caused to assume a first colour, for example, green. When an acknowledgement of receipt of that message by the postal authority is received by the mailer from the postal authority, the cell is caused to assume a second colour, for example, blue.

In a preferred embodiment, a time-out function is provided by the computer 18, whereby, after the sending of a message by the mailer, if an acknowledgement of that message is not received from the postal authority, or the postal authority has not agreed the message, within a predetermined period of time, the cell corresponding to that message is caused to assume a third colour, for example, red.

Accordingly, the operator of the system can easily determine the progress of the batches of mail by noting the colour of each cell in a row of cells relating to any selected batch of mail and also determine if there has been a failure in the communication or agreement in respect of any message relating to any of the batches of mail.

As illustrated in FIG. 6, the message status screen also includes columns of cells relating to the receipt of messages from the postal authority, namely the ‘Acknowledgement Induction Message’, the ‘Induction Acceptance Message’ and the ‘Agreed Message’. It will be appreciated that it is only necessary to indicate that these messages have been received from the postal authority, and hence the respective cells have either a background colour when no message has been received, or a different predetermined colour, for example, blue, when the message has been received. Thus, initially, in respect of a batch of mail which is intended to be prepared, but which has not been completed, the cell relating to the ‘Pre-Announcement Message’ will be green, and then turn blue when an acknowledgement of the ‘Pre-Announcement Message’ has been received. As the preparation and handling of the batch of mail proceeds, the cells in the row relating to a batch of mail progressively become blue. Accordingly, if all the cells of a row relating to a batch are blue, the operator can easily see that the batch has been successfully prepared, received by the postal authority and fully accepted by the postal authority. If any cell is red, the operator is alerted that there has been a failure in a communication with the postal authority. Also, the colour of cells in any row of cells provides an indication to the operator of the status of the mailing preparation.

Finally, it will be understood that the present invention has been described in its preferred embodiment and can be modified in many different ways without departing from the scope of the invention as defined by the appended claims.

For example, if the display 24 is monochrome, the status of the messages associated with the cells may be represented by different grey scale shades or by different hatching of the cells to enable the status of messages indicated by the respective cells to be distinguished and recognised by the operator.

1. A mail preparation system, including:
a postage charge dispenser configured to generate postage indicia and account for postage charges;
a printer operable to print the postage indicia as generated by the postage charge dispenser on mail items;
a display;
a controller for driving the display to display a depiction of a postage indicium to be printed on a mail item, the depicted postage indicium including a plurality of data items modifiable by a user, which data items include at least one data item related to postage charge, and being operable to provide data representative of the data items to the postage charge dispenser;
a data item selector operable by the user to select any one of the data items in the depicted postage indicium and cause the controller to drive the display to display a plurality of possible item entries for the selected data item; and
an item entry selector operable by the user to select one of the possible item entries for the selected data item and cause the controller to drive the display to display a modified depiction of the postage indicium including the selected item entry for the data item.

2. The system of claim 1, wherein the data item selector comprises a screen pointing device.

3. The system of claim 2, wherein the screen pointing device comprises one of a mouse, a tracker ball, a touch pad or a touch screen.

4. The system of claim 1, wherein the item entry selector comprises a screen pointing device.

5. The system of claim 4, wherein the screen pointing device comprises one of a mouse, a tracker ball, a touch pad or a touch screen.

6. The system of claim 1, wherein the possible item entries for the selected data item are superimposed on the depiction of the postage indicium.

7. The system of claim 1, wherein the data items include postage value.

8. The system of claim 1, wherein the data items include postage class.

9. The system of claim 1, wherein the data items include date.

10. The system of claim 1, wherein the data items include destination.

11. The system of claim 10, wherein the destinations are represented on a map.

12. The system of claim 1, further including:
a weighscale for determining the weight of mail items, the weighscale being operable to provide data representative of the weight of a mail item to the controller and the controller being configured automatically to select the postage value for the mail item.

13. A method of preparing mail items, including the steps of:
displaying a depiction of a postage indicium to be printed on a mail item, the depicted postage indicium including a plurality of data items modifiable by a user, which data items include at least one data item related to postage charge;
selecting one of the data items in the depicted postage indicium to be modified;
displaying a plurality of possible item entries for the selected data item;
selecting one of the possible item entries for the selected data item;
displaying a modified depiction of the postage indicium including the selected item entry for the data item;
generating a postage indicium corresponding to the modified depiction of the postage indicium; and
printing the postage indicium on a mail item.

14. The method of claim 13, wherein the possible item entries for the selected data item are superimposed on the depiction of the postage indicium.

15. The method of claim 13, wherein the data items include postage value.

16. The method of claim 13, wherein the data items include postage class.

17. The method of claim 13, wherein the data items include date.

18. The method of claim 13, wherein the data items include destination.

19. The method of claim 18, wherein the destinations are represented on a map.

20. The method of claim 13, further including the step of:
weighing the mail item, whereby the weight of the mail item is utilised automatically to select the postage value for the mail item.

21. A mail preparation system for preparing batches of mail, the system including:
a message transmitter operable to transmit messages relating to batches of mail to a remote data center;
a message receiver for receiving messages from the remote data center as an acknowledgement in reply to each transmitted message;
a display for displaying message areas corresponding to each transmitted message; and
a controller for operating the display to display the message areas with a first visual appearance on transmission of the respective messages to the remote data center and a second, different visual appearance on receipt of the respective messages from the remote data center.

22. The system of claim 21, wherein the controller includes a time-out function for displaying message areas with a third, different visual appearance where a message is not received from the remote data center within a predetermined period of time following transmission of the message to the remote data center.

23. The system of claim 21, wherein the different visual appearances are represented by different colours.

24. The system of claim 21, wherein the different visual appearances are represented by different shades.

25. The system of claim 21, wherein the different visual appearances are represented by different patterns.

26. The system of claim 21, wherein the different visual appearances are represented by different characters.

27. A method of preparing batches of mail, the method including the steps of:
transmitting messages relating to batches of mail to a remote data center;
receiving messages from the remote data center as an acknowledgement in reply to the transmitted messages; and
displaying message areas on a display corresponding to each transmitted message, the message areas being displayed with a first visual appearance on transmission of the respective messages to the remote data center and a second, different visual appearance on receipt of the respective messages from the remote data center.

28. The method of claim 27, further including the step of:
displaying message areas with a third, different visual appearance where a message is not received from the remote data center within a predetermined period of time following transmission of the message to the remote data center.

29. The method of claim 27, wherein the different visual appearances are represented by different colours.

30. The method of claim 27, wherein the different visual appearances are represented by different shades.

31. The method of claim 27, wherein the different visual appearances are represented by different patterns.

32. The method of claim 27, wherein the different visual appearances are represented by different characters.
